(19) United States
(12) Patent Application Publication
(10) Pub. No.: US 2019/0251483 A1
(43) Pub. Date: Aug. 15, 2019

(54) CIRCULATION ROUTE CREATION SUPPORT PROGRAM AND CIRCULATION ROUTE CREATION SUPPORT METHOD

(71) Applicant: FUJITSU LIMITED, Kawasaki-shi (JP)

(72) Inventor: Nobumi Noro, Aomori (JP)

(73) Assignee: FUJITSU LIMITED, Kawasaki-shi (JP)

(21) Appl. No.: 16/391,769

(22) Filed: Apr. 23, 2019

Related U.S. Application Data
(63) Continuation of application No. PCT/JP2016/082890, filed on Nov. 4, 2016.

(51) Int. Cl. G06Q 10/02; G06Q 50/14

(52) U.S. Cl. CPC G06Q 10/025; G06Q 50/14

(57) ABSTRACT

A recording medium recording a circulation route creation support program for causing a computer to execute a process includes: outputting, when accepting a search request for a spot, information related to one or more spots which satisfy a condition of the search request; referring to, when one of the spots is selected as a first spot, a first storage part that stores a spot and a position of the spot in association with each other, and acquiring a position of the first spot; and referring to a second storage part that stores circulation routes each including at least one or more spots and, based on a position of the at least one or more spots included in each of the circulation routes and the acquired position of the first spot, specifying a circulation route as an addition candidate for the selected first spot, from among the circulation routes.

### CROSS-REFERENCE TO RELATED APPLICATION

This application is a continuation application of International Application PCT/JP2016/082890 filed on Nov. 4, 2016 and designated the U.S., the entire contents of which are incorporated herein by reference.

### FIELD

The embodiments discussed herein are related to a circulation route creation support program, a circulation route creation support method, and a circulation route creation support device.

### BACKGROUND

Each municipality provides information regarding tourist spots. In recent years, as a service utilizing such information on tourist spots, a user selects a tourist spot by himself/herself to generate a tourist route and a tourist spot fitting to a user's profile is automatically suggested.

Japanese Laid-open Patent Publication No. 2010-3158, Japanese Laid-open Patent Publication No. 2001-195459, and Japanese Laid-open Patent Publication No. 2010-146129 are disclosed as related art.

### SUMMARY

According to an aspect of the embodiments, a non-transitory computer-readable recording medium having stored therein a circulation route creation support program for causing a computer to execute a process includes: outputting, when accepting a search request for a spot, information related to one or more spots which satisfy a condition of the search request; referring to, when any one of the output one or more spots is selected as a first spot, a first storage part that stores a spot and a position of the spot in association with each other, and acquiring a position of the first spot; and referring to a second storage part that stores a plurality of circulation routes each including at least one or more spots and, on the basis of a position of the at least one or more spots included in each of the plurality of circulation routes and the acquired position of the first spot, specifying a circulation route as an addition candidate for the selected first spot, from among the plurality of circulation routes.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an overall configuration of a system according to a first embodiment;

FIG. 2 is a functional block diagram illustrating a functional configuration of a route generation server according to the first embodiment;

FIG. 3 is a diagram illustrating an example of information stored in a tourist spot information database (DB);

FIG. 4 is a diagram illustrating an example of information stored in a route information DB;

FIG. 5 is a diagram for explaining an example of browsing tourist spots and generating a new route;

FIG. 6 is a diagram for explaining an example of adding a tourist spot;

FIG. 7 is a diagram for explaining the generation and editing of a tourist route across websites;

FIG. 8 is a flowchart illustrating a flow of a new route generation process;

FIG. 9 is a flowchart illustrating a flow of an automatic tourist spot addition process;

FIG. 10 is a flowchart illustrating a flow of an addition destination route specifying process;

FIG. 11 is a diagram illustrating information stored in a route information DB, with which areas are associated;

FIG. 12 is a diagram illustrating information stored in the route information DB, with which identifiers are associated;

FIG. 13 is a diagram illustrating information stored in the route information DB, with which ways of movement are associated;

FIG. 14 is a diagram illustrating information stored in the route information DB, with which time information is associated; and

FIG. 15 is a diagram illustrating an example of a hardware configuration.

### DESCRIPTION OF EMBODIMENTS

When a new tourist spot is selected with a plurality of tourist routes created, it is not easy to judge to which tourist route the new tourist spot is to be added.

A user who is a tourist often has no acquaintance with a region for which a tourist route for tourist purpose is created. In addition, the user often examines a plurality of tourist routes for a region to be visited for tourism. In such a case, it is not easy for the user not acquainted with the region to judge to which tourist route the new tourist spot is to be added, in order to create an efficient route.

Furthermore, although it is also conceivable to add the new tourist spot to each of the created tourist routes to compare and examine, the more routes to be examined, the more time consuming and the less convenient; it is thus hard to say that this is a good approach. These difficulties are not restricted to tourist routes, but also similarly occur, for example, in circulation routes that security guards go along.

In one aspect, a circulation route creation support program, a circulation route creation support method, and a circulation route creation support device capable of properly specifying a route to accept addition may be provided.

Embodiments of a circulation route creation support program, a circulation route creation support method and a circulation route creation support device according to the present disclosure will be described in detail below with reference to the drawings. Note that the present disclosure is not limited by these embodiments.

### First Embodiment

[Overall Configuration]

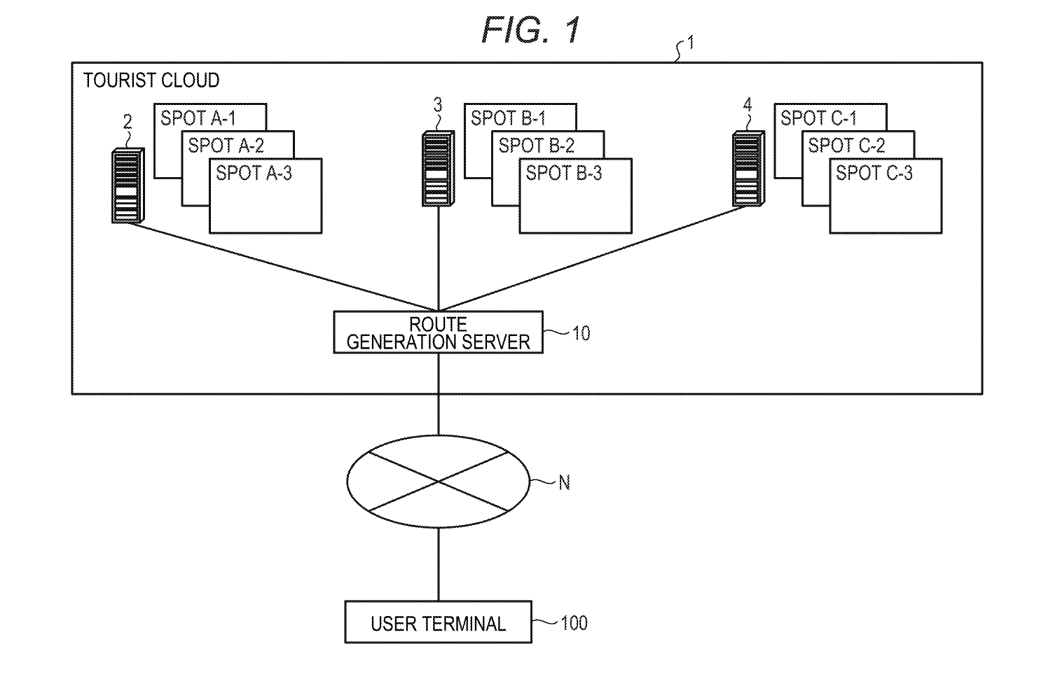

FIG. 1 is a diagram illustrating an example of the overall configuration of a system according to a first embodiment. As illustrated in FIG. 1, in this system, a tourist cloud 1 and a user terminal 100 are coupled via a network N. Any type of communication network such as a local area network (LAN) and a virtual private network (VPN), as well as the Internet can be adopted for the above-mentioned network N regardless of wired form or wireless form.

The tourist cloud 1 is a system having a route generation server 10 and a plurality of tourist servers 2 to 4 and is a cloud system using cloud computing. Note that the number of servers and the like illustrated in FIG. 1 is merely an example and the number is not limited.

The tourist servers 2 to 4 are an example of a server device that provides the user terminal 100 with a web page (hereinafter referred to as an introduction page in some cases) introducing a tourist spot (hereinafter referred to as a spot in some cases). The tourist spot is, for example, a tourist attraction to which the user wants to make tourism in trip and the like, such as ruins, festivals, and world heritage. In addition, the respective tourist servers 2 to 4 are administered by different municipalities, different corporations, and the like.

For example, the tourist server 2 manages respective web pages introducing tourist spots A-1, A-2, and A-3. The tourist server 3 manages respective web pages introducing tourist spots B-1, B-2 and B-3. The tourist server 4 manages respective web pages introducing tourist spots C-1, C-2, and C-3.

FIG. 1 illustrates an example in which the tourist servers 2 to 4 are coupled to the network N via the route generation server 10; however, the connection is not limited to this example and the tourist servers 2 to 4 and the route generation server 10 may be coupled via the network N.

The route generation server 10 is an example of a server device configured to provide an introduction page for introducing a tourist spot searched by a user and generate a tourist route for making tourism to the tourist spot selected by the user. For example, upon accepting a search command for a tourist spot from the user terminal 100, the route generation server 10 acquires an introduction page that introduces the corresponding tourist spot from a corresponding tourist server among the tourist servers 2 to 4 and displays the acquired introduction page on the user terminal 100.

In this manner, the route generation server 10 provides the user with the web page of the tourist spot searched by the user. In addition, the route generation server 10 generates a tourist route by way of the tourist spot selected by the user as a tourist destination from among the tourist spots provided by the tourist servers 2 to 4 and browsed by the user.

A variety of known technologies can be adopted as the generation technique for the tourist route. For example, the route generation server 10 specifies ways of movement and moving time between the selected tourist spots, using, for example, transportation ways and time information on trains or the like managed by a server (not illustrate) to generate a tourist route.

The user terminal 100 is an example of a computer used by a user scheduling a trip for tourism or the like and is, for example, a personal computer, a smartphone, a tablet terminal or the like. For example, on the user terminal 100, the route generation server 10 is accessed and a search condition such as “xxx temple” is input; then, the introduction page of “xxx temple” is browsed. In this manner, the user terminal 100 designates the tourist destination through browsing of the introduction page of the desired tourist spot and generates a tourist route on the route generation server 10.

In such a system, the route generation server 10 acquires the address of the web page introducing the tourist spot from each tourist server, and refers to a first storage part that stores the address of the web page in association with the tourist spot and the position of the tourist spot, to acquire the tourist spot and the position of the tourist spot associated with the acquired address. Subsequently, the route generation server 10 refers to a second storage part that stores a plurality of tourist routes each including at least one or more tourist spots, and, on the basis of the position of the tourist spot included in each of the plurality of tourist routes and the acquired position of the tourist spot, specifies a tourist route as an addition candidate for the acquired tourist spot, from among the plurality of tourist routes.

For example, the route generation server 10 accepts the selection of a tourist spot A as a new tourist destination while a plurality of tourist routes has been generated and saved. Thereafter, the route generation server 10 calculates the distance between each tourist spot included in each of the generated tourist routes and the tourist spot A, for each generated tourist route. Then, the route generation server 10 presents a tourist route including a tourist spot located at the closest position to the tourist spot A, to the user as a tourist route to which the tourist spot A is to be added. Through this procedure, the route generation server 10 can properly specify the tourist route to accept addition.

[Functional Configuration]

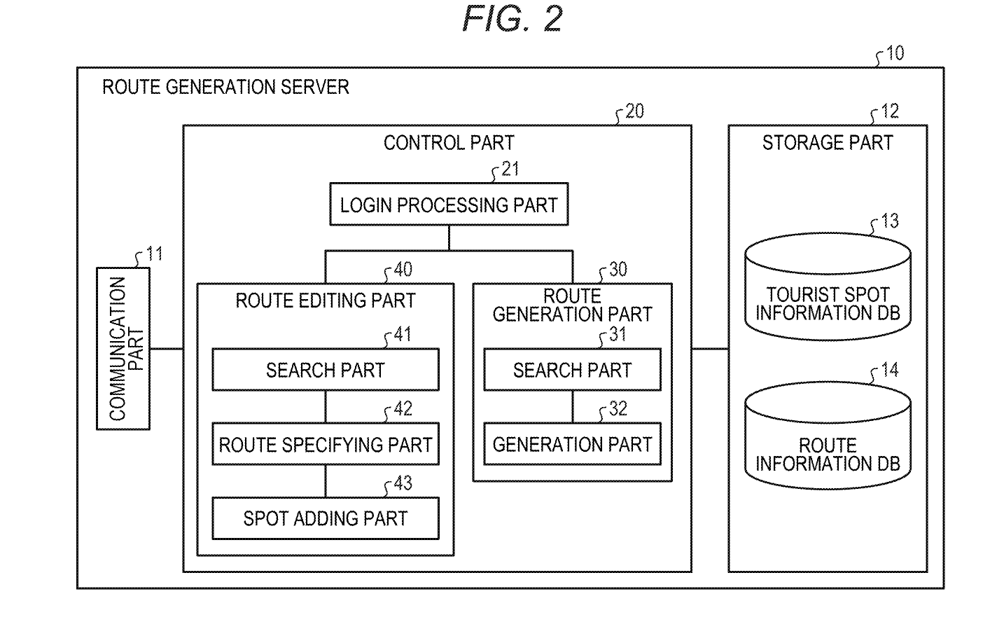

FIG. 2 is a functional block diagram illustrating a functional configuration of the route generation server 10 according to the first embodiment. As illustrated in FIG. 2, the route generation server 10 has a communication part 11, a storage part 12, and a control part 20.

The communication part 11 is a processing part that controls communication with other devices, such as a communication interface. For example, the communication part 11 receives a search command, a route generation instruction, a route edit instruction, and the like from the user terminal 100 and transmits various sorts of results to the user terminal 100.

The storage part 12 is an example of a storage device that stores programs and data and is, for example, a memory, a hard disk or the like. The storage part 12 stores a tourist spot information DB 13 and a route information DB 14. The tourist spot information DB 13 is an example of the first storage part and the route information DB 14 is an example of the second storage part.

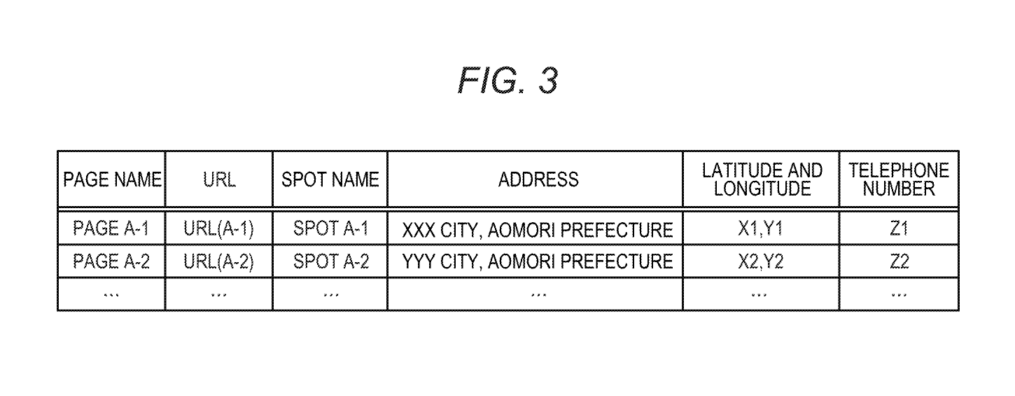

The tourist spot information DB 13 is a database for storing information regarding tourist spots introduced by each of the tourist servers 2 to 4. FIG. 3 is a diagram illustrating an example of information stored in the tourist spot information DB 13. As illustrated in FIG. 3, the tourist spot information DB 13 stores, for example, “page name, URL, spot name, address, latitude and longitude, telephone number” in association with each other.

“Page name” is the name of a web page introducing a tourist spot and “uniform resource locator (URL)” is information for specifying the location or the like of the web page introducing the tourist spot. “Spot name” is the name or the like of the introduced tourist spot and “address” is the address of the introduced tourist spot. “Latitude and longitude” is position information on the introduced tourist spot and “telephone number” is the telephone number of the introduced tourist spot.

The example in FIG. 3 indicates that a spot with a spot name “spot A-1” is introduced, of which the page name (page A-1) is specified by the URL (URL(A-1)), the address is “xxx city, Aomori prefecture”, the latitude and longitude are “X1, Y1” and the telephone number is “Z1”.

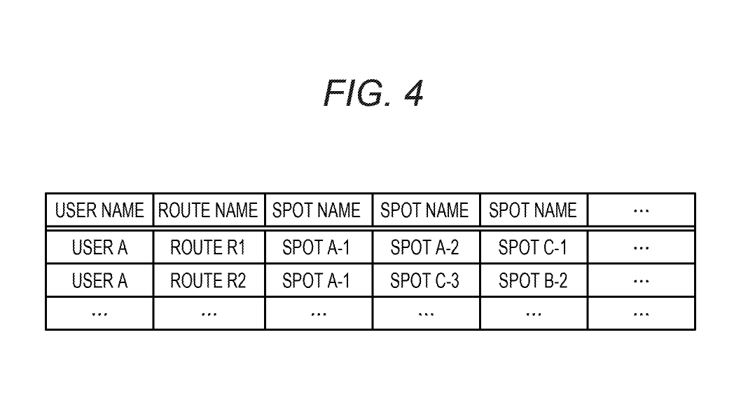

The route information DB 14 is a database for storing information regarding generated tourist routes each including at least one or more tourist spots. FIG. 4 is a diagram illustrating an example of information stored in the route information DB 14. As illustrated in FIG. 4, the route information DB 14 stores “user name, route name, spot name” in association with each other.

“User name” stored here is information for identifying the user who generated the tourist route. “Route name” is information for identifying the generated tourist route. “Spot name” is information for specifying the tourist spot included in the tourist route. The first line in FIG. 4 stores information regarding a route R1 generated by a user A and indicates that the route R1 includes spots A-1, A-2, and C-1 as tourist spots.

The control part 20 is a processing part that supervises the entire process of the route generation server 10 and is, for example, a processor. The control part 20 has a login processing part 21, a route generation part 30, and a route editing part 40. The login processing part 21, the route generation part 30, and the route editing part 40 are examples of electronic circuits such as processors, or examples of processes executed by the processor, or the like.

The login processing part 21 is a processing part that transmits, to the user terminal 100, a login screen for authenticating that a person attempting login is an authorized user of the tourist cloud 1, and executes a login process. For example, upon accepting an access from the user terminal 100, the login processing part 21 responds to the user terminal 100 with a login screen. Then, when the combination of the user name and the password accepted on the login screen matches the combination registered in advance, the login processing part 21 permits the login.

In addition, the login processing part 21 prompts the login user to select new tourist route generation or tourist route editing at the time of login. Then, when the login is permitted with the new tourist route generation selected, the login processing part 21 notifies the route generation part 30 of the start of process. Alternatively, when the login is permitted with the tourist route editing selected, the login processing part 21 notifies the route editing part 40 of the start of process. When the login is not permitted by the login processing part 21, an error screen or the like is displayed.

The route generation part 30 is a processing part that has a search part 31 and a generation part 32 and generates a new tourist route. The search part 31 is a processing part that executes a search for a tourist spot. For example, when the start of process is instructed from the login processing part 21, the search part 31 displays a search screen on the user terminal 100.

Then, the search part 31 acquires, from one of the tourist servers, a web page that introduces a tourist spot corresponding to a search word (keyword) input on the search screen, and responds to the user terminal 100 with the acquired web page. Furthermore, every time the search word is updated or re-input until the termination operation is accepted from the user terminal 100, the search part 31 searches for and displays the web page of the corresponding tourist spot. The search part 31 is an example of a first output part.

The generation part 32 is a processing part that generates a tourist route. For example, the generation part 32 generates a tourist route by way of a tourist spot selected as a place to be visited for tourism in the web page of the tourist spot displayed by the search part 31. Then, the generation part 32 associates the user name being logged in with the generated tourist route to retain in the route information DB 14.

To give an example, the generation part 32 accepts the selection of the tourist spots A-1, A-2, and C-1 among a plurality of tourist spots displayed by the search part 31. Thereafter, the generation part 32 acquires the latitude and longitude of each of the tourist spots A-1, A-2, and C-1 from the tourist spot information DB 13 and calculates the distances between the respective tourist spots. Then, the generation part 32 generates a tourist route such that the moving distance to each tourist spot becomes the shortest. When searching and selecting are executed repeatedly a plurality of times by the search part 31, it can be determined that the repeatedly executed searching and selecting are a series of processes by the same user, by correlating the web screen with a Cookie.

The route editing part 40 is a processing part that has a search part 41, a route specifying part 42, and a spot adding part 43, and executes addition and deletion of a tourist spot and deletion of the whole tourist route with respect to the generated tourist route. The route specifying part 42 is an example of a second acquisition part and a specifying part.

For example, when the start of process is instructed from the login processing part 21, the route editing part 40 transmits, to the user terminal 100, a screen for prompting the route selection, route deletion, tourist spot addition, or the like. Then, when the route selection is selected by the user terminal 100, the route editing part 40 acquires the route name of the generated tourist route from the route information DB 14 and displays a tourist route list. When one of the tourist routes is selected from the tourist route list at this point, the route editing part 40 displays a map illustrating the selected tourist route and a tourist spot included in the selected tourist route, a list of tourist spots included in the selected tourist route, and the like.

When the route deletion is selected by the user terminal 100 from among the route selection, the route deletion, and the tourist spot addition, the route editing part 40 acquires the route name of the generated tourist route from the route information DB 14 and displays a tourist route list. When one of the tourist routes is selected from the tourist route list at this point, the route editing part 40 deletes the selected tourist route from the route information DB 14.

When the tourist spot addition is selected by the user terminal 100 from among the route selection, the route deletion, and the tourist spot addition, the route editing part 40 instructs the search part 41 to start a process.

The search part 41 is a processing part that displays a search screen on the user terminal 100 when the start of process is instructed from the route editing part 40. Since the search process is a process similar to the process of the search part 31, a detailed description will be omitted.

The route specifying part 42 is a processing part that, when a new tourist spot is selected, specifies a proper tourist route as the addition destination of the new tourist spot. For example, when a tourist spot to be added is selected from a web page displayed by the search part 41, the route specifying part 42 acquires address information on the web page. Subsequently, the route specifying part 42 acquires a position (latitude and longitude) relative to the acquired address information from the tourist spot information DB 13. Then, the route specifying part 42 specifies a tourist route as an addition candidate for the tourist spot to be added, on the basis of the position of the tourist spot included in each generated tourist route and the position of the tourist spot to be added.

For example, when accepting a selection to add the tourist spot B-2 from a web page displayed by the search part 41, the route specifying part 42 acquires position information (latitude and longitude) on the tourist spot B-2 from the tourist spot information DB 13. Subsequently, the route specifying part 42 executes the following process with respect to each of the generated tourist routes stored in the route information DB 14.

For example, the route specifying part 42 specifies each tourist spot included in the generated tourist route and acquires position information (latitude and longitude) on each tourist spot from the tourist spot information DB 13. Then, for each specified tourist spot, the route specifying part 42 calculates the distance between the tourist spots from the position information (latitude and longitude) on the specified tourist spot and the position information (latitude and longitude) on the tourist spot B-2. Then, the route specifying part 42 specifies an adjacent tourist spot located at the shortest distance and this shortest distance among the distances calculated for each specified tourist spot.

In this manner, the route specifying part 42 specifies an adjacent tourist spot that is the most adjacent to the tourist spot B-2 to be added and the distance between the tourist spots, for each generated tourist route. Then, the route specifying part 42 specifies an adjacent tourist spot with the shortest distance from among the adjacent tourist spots. Thereafter, the route specifying part 42 designates a tourist route including the adjacent tourist spot with the shortest distance as a tourist route as the addition destination.

Then, the route specifying part 42 transmits, to the user terminal 100, a generated tourist route list highlighting only the tourist route specified as the addition destination. At this time, when a plurality of adjacent tourist spots with the shortest distance is specified, the route specifying part 42 highlights each tourist route including each adjacent tourist spot as a candidate for addition destination. The route specifying part 42 specifies the adjacent tourist spot with the shortest distance; however, when the shortest distance is equal to or longer than a threshold value, the route generation part 30 may also be supplied with a command to generate a new route starting from this adjacent tourist spot.

The spot adding part 43 is a processing part that automatically adds the tourist spot to be added to the tourist route specified as the addition destination. For example, the spot adding part 43 acquires information regarding the tourist spot to be added and information regarding the tourist route as the addition destination from the route specifying part 42. Then, the spot adding part 43 adds the tourist spot to be added to the tourist route as the addition destination and executes the reconstruction of the tourist route using a technique similar to when generating a new route. Thereafter, the spot adding part 43 updates the route information DB 14 with information on the reconstructed tourist route.

For example, the spot adding part 43 acquires information regarding the tourist spot B-2 to be added from the route specifying part 42. Then, the spot adding part 43 adds the tourist spot B-2 to the tourist route as the addition destination after the tourist route as the addition destination is highlighted for a certain time by the route specifying part 42. When another tourist route is selected via the user terminal 100 while the tourist route as the addition destination is being highlighted, the spot adding part 43 can also add the tourist spot B-2 to be added to the selected another tourist route.

[Specific Examples of Processes]

Next, specific examples of the screen display and each process will be described. In this section, a description will be given of specific examples of a new route generation process and a tourist spot addition process.

(Generation of New Route)

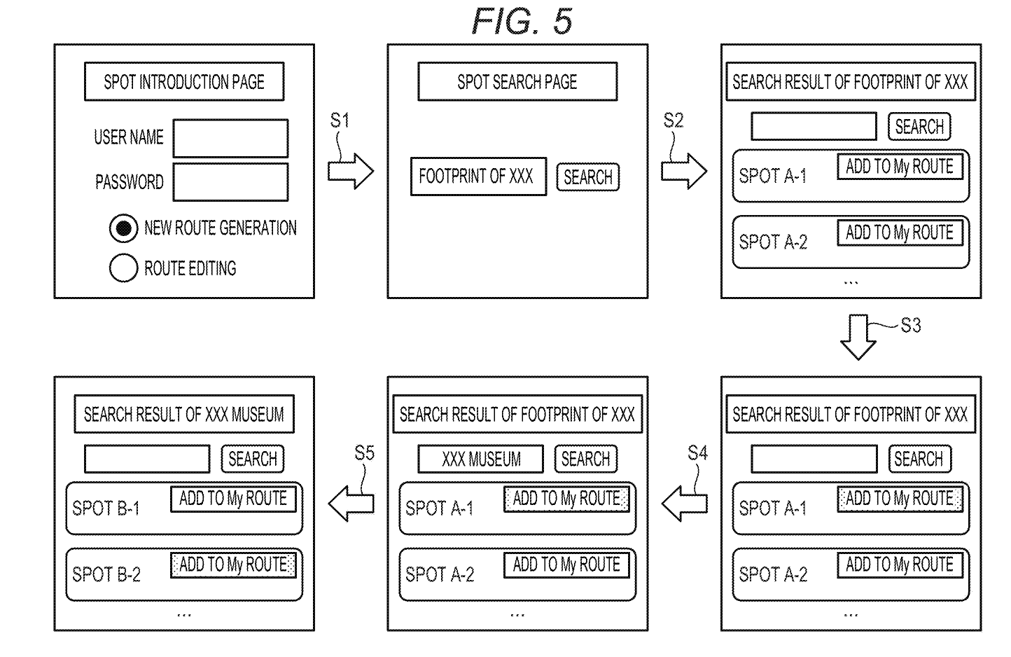

FIG. 5 is a diagram for explaining an example of browsing tourist spots and generating a new route. As illustrated in FIG. 5, when the login processing part 21 permits login while “new route generation” is being selected, the search part 31 of the route generation part 30 displays a search screen (spot search page) on the user terminal 100 (S1).

Subsequently, when detecting pressing of a search button after accepting the input of “footprint of xxx” as a search word, the search part 31 acquires the introduction page of a tourist spot corresponding to “footprint of xxx” from each tourist server and displays the acquired introduction page on the user terminal 100 as a search result (S2). In the example in FIG. 5, a web page including the introduction of a spot A-1 and the introduction of a spot A-2 is displayed as the search result of “footprint of xxx”.

Thereafter, upon accepting the selection of “add to my route” for the spot A-1 in the search result of “footprint of xxx”, the generation part 32 generates a new tourist route including the spot A-1 (S3). At this time, the generation part 32 retains information regarding the new tourist route in the route information DB 14.

Furthermore, when accepting the input of “xxx museum” and detecting pressing of the search button while the search result of “footprint of xxx” is being displayed, the search part 31 acquires the introduction page of a tourist spot corresponding to “xxx museum” from each tourist server and displays the acquired introduction page on the user terminal 100 as a search result (S4 and S5). In the example in FIG. 5, a web page including the introduction of a spot B-1 and the introduction of a spot B-2 is displayed as the search result of “xxx museum”.

Thereafter, upon accepting the selection of “add to my route” for the spot B-2 in the search result of “xxx museum”, the generation part 32 updates the tourist route generated when the spot A-1 is selected to a tourist route including the spot A-1 and the spot B-2. At this time, the generation part 32 updates the route information DB 14. In this manner, the route generation part 30 repeats a search for a tourist spot and the addition to my route to generate a tourist route.

(Editing of Route)

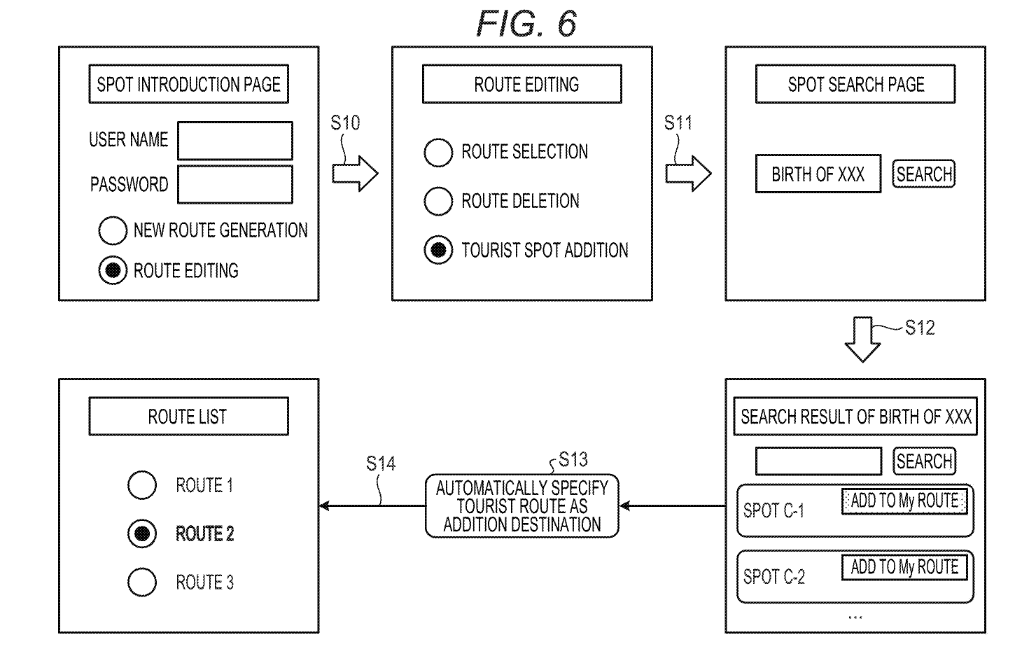

FIG. 6 is a diagram for explaining an example of adding a tourist spot. As illustrated in FIG. 6, when the login processing part 21 permits login while “route editing” is being selected, the route editing part 40 displays a screen for prompting the selection of “route selection”, “route deletion”, or “tourist spot addition” on the user terminal 100 (S10).

Subsequently, when “tourist spot addition” is selected, the search part 41 displays a search screen (spot search page) on the user terminal 100 (S11). Thereafter, when detecting pressing of a search button after accepting the input of “birth of xxx” as a search word, the search part 41 acquires the introduction page of a tourist spot corresponding to “birth of xxx” from each tourist server and displays the acquired introduction page on the user terminal 100 as a search result (S12). In the example in FIG. 6, a web page including the introduction of a spot C-1 and the introduction of a spot C-2 is displayed as the search result of “birth of xxx”.

Thereafter, upon accepting the selection of “add to my route” for the spot C-1 in the search result of “birth of xxx”, the route specifying part 42 automatically specifies a tourist route as the addition destination using position information on the spot C-1 and the like (S13).

Then, the route specifying part 42 displays, on the user terminal 100, a route list highlighting a route R2, which is a tourist route automatically specified as the addition destination, and the spot adding part 43 adds the spot C-1 to the route R2 and executes the reconstruction of the route R2 (S14). At this time, the spot adding part 43 updates information on the route R2 retained in the route information DB 14. In this manner, the route generation part 30 repeats a search for a tourist spot and the addition to my route to automatically add the new spot to the tourist route.

[Specific Example of System]

As described above, by utilizing the tourist cloud 1, the user is enabled to access websites managed by different companies and search for a tourist spot. In addition, the user is enabled to search for a tourist spot and generate a tourist route across websites of different companies. Therefore, in this section, a tourist spot search and tourist route generation and editing will be described from the user's viewpoint.

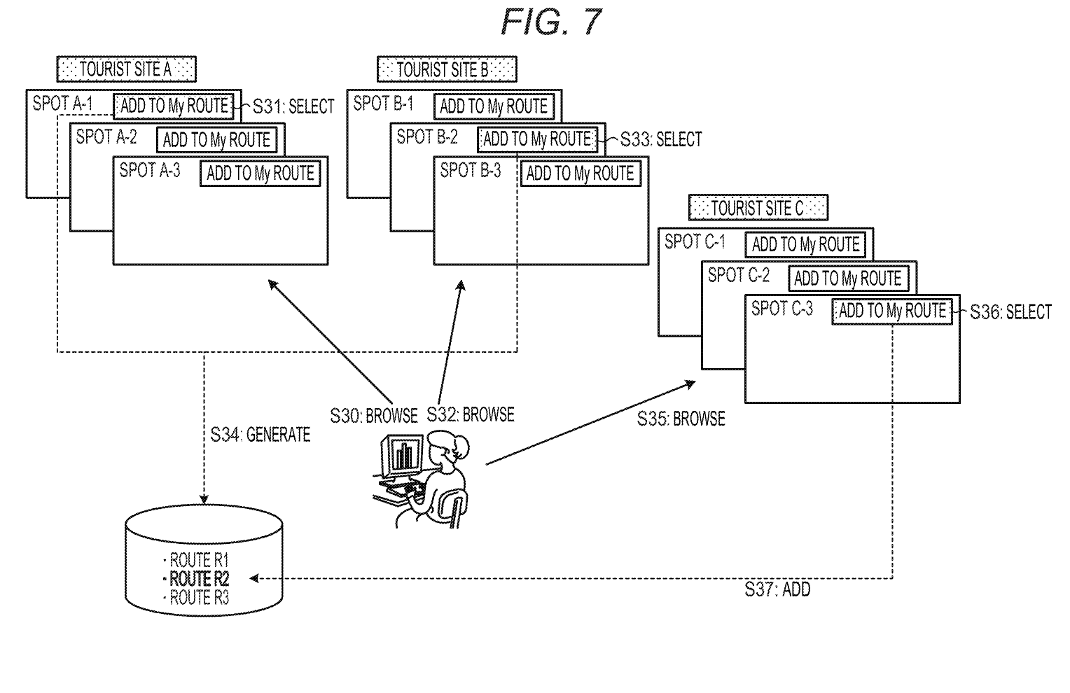

FIG. 7 is a diagram for explaining the generation and editing of a tourist route across websites. As illustrated in FIG. 7, on the user terminal 100, a tourist site A on the tourist cloud 1 is browsed (S30) and “add to my route” is selected for a spot A-1 (S31).

Subsequently, on the user terminal 100, a tourist site B on the tourist cloud 1 is browsed (S32) and “add to my route” is selected for a spot B-2 (S33). Then, the user terminal 100 generates a tourist route for making tourism to the spots A-1 and B-2 added to my route (S34).

In this manner, on the user terminal 100, after routes R1, R2, and R3 are generated as tourist routes, a tourist site C on the tourist cloud 1 is browsed (S35) and “add to my route” is selected for a spot C-3 (S36). Thereafter, the spot C-3 is automatically added to the route R2 presumed to allow efficient tourism to the spot C-3 (S37).

[Flow of Processes]

Next, the new route generation process and the tourist spot addition process will be described. Since processes similar to usual processes can be adopted for the route deletion and the like, a detailed description will be omitted.

(New Route Generation Process)

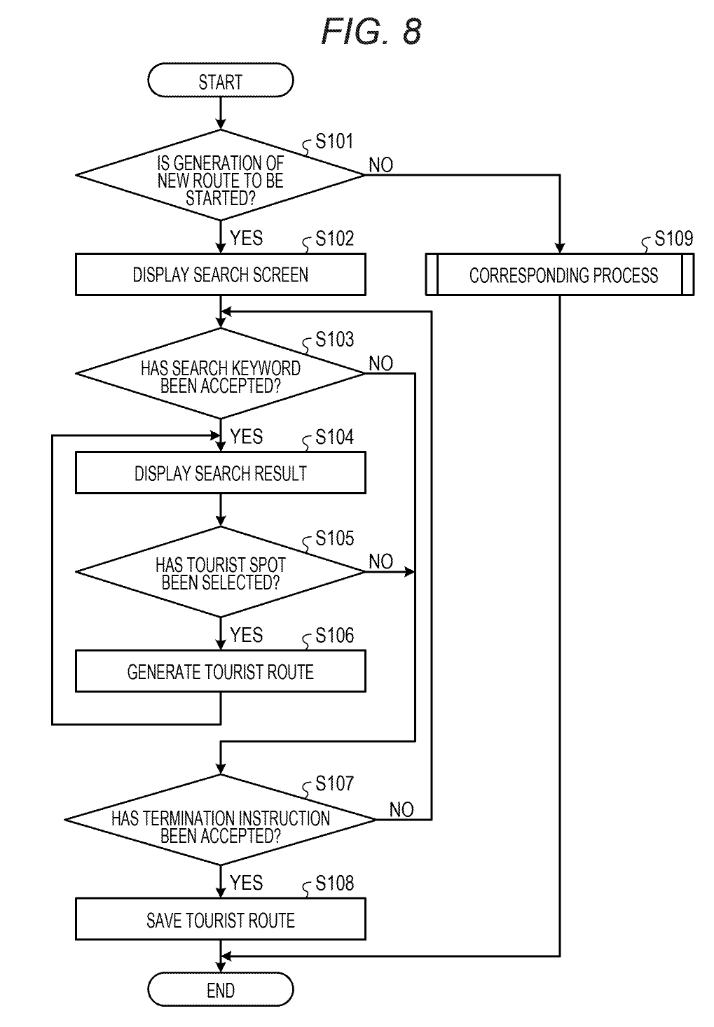

FIG. 8 is a flowchart illustrating a flow of the new route generation process. As illustrated in FIG. 8, upon accepting an instruction to start the generation of a new route (S101: Yes), the route generation part 30 displays a search screen (S102).

Subsequently, upon accepting a search keyword (S103: Yes), the route generation part 30 displays the search result (S104). Thereafter, when a tourist spot is selected from the search result (S105: Yes), the route generation part 30 generates a tourist route using the selected tourist spot (S106) and repeats S104 and the following steps.

On the other hand, when no tourist spot is selected (S105: No) and a termination instruction is accepted (S107: Yes), the route generation part 30 saves the generated tourist route in the route information DB 14 (S108). When no tourist spot is selected (S105: No) and also the termination instruction is not accepted (S107: No), the route generation part 30 repeats S103 and the following steps.

Also when no search keyword is accepted (S103: No) and the termination instruction is accepted (S107: Yes), the route generation part 30 executes S108. When no search keyword is accepted (S103: No) and also the termination instruction is not accepted (S107: No), the route generation part 30 repeats S103 and the following steps.

In S101, upon accepting an instruction to start another process instead of an instruction to start the generation of a new route (S101: No), a corresponding process is executed (S109).

(Automatic Tourist Spot Addition Process)

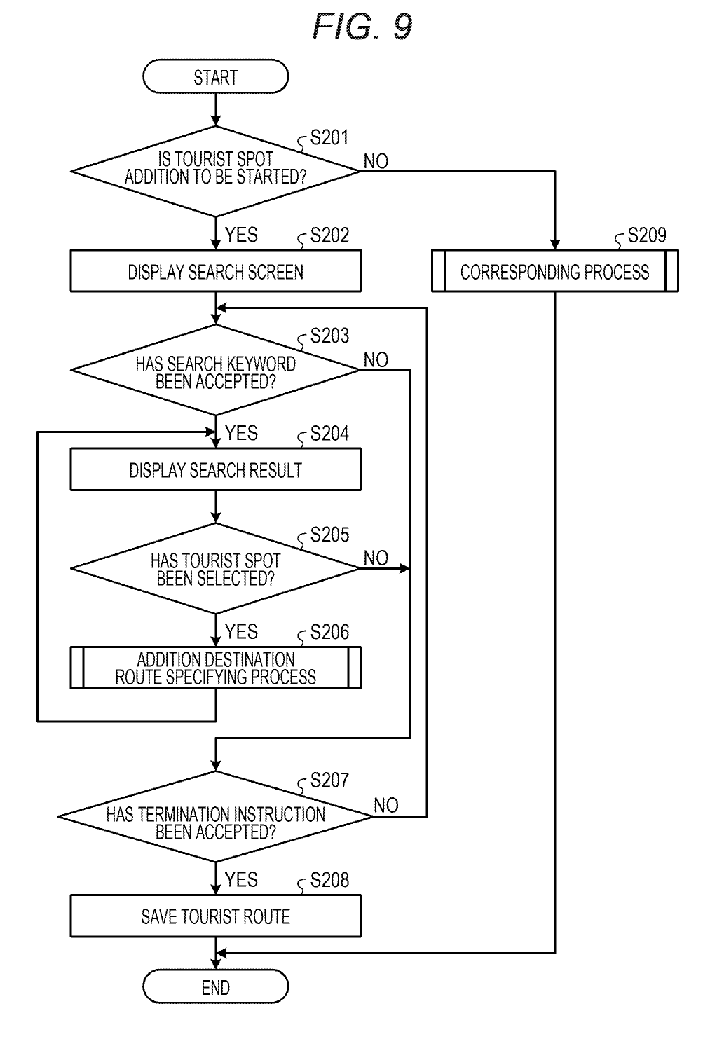

FIG. 9 is a flowchart illustrating a flow of an automatic tourist spot addition process. As illustrated in FIG. 9, upon accepting an instruction to start the tourist spot addition process (S201: Yes), the route editing part 40 displays a search screen (S202).

Subsequently, upon accepting a search keyword (S203: Yes), the route editing part 40 displays the search result (S204). Thereafter, when a tourist spot is selected from the search result (S205: Yes), the route editing part 40 executes an addition destination route specifying process (S206) and repeats S204 and the following steps.

On the other hand, when no tourist spot is selected (S205: No) and a termination instruction is accepted (S207: Yes), the route editing part 40 saves the edited tourist route in the route information DB 14 (S208). When no tourist spot is selected (S205: No) and also the termination instruction is not accepted (S207: No), the route editing part 40 repeats S203 and the following steps.

Also when no search keyword is accepted (S203: No) and the termination instruction is accepted (S207: Yes), the route editing part 40 executes S208. When no search keyword is accepted (S203: No) and also the termination instruction is not accepted (S207: No), the route editing part 40 repeats S203 and the following steps.

In S201, upon accepting an instruction to start another process instead of an instruction to start the tourist spot addition process (S201: No), a corresponding process is executed (S209).

(Addition Destination Route Specifying Process)

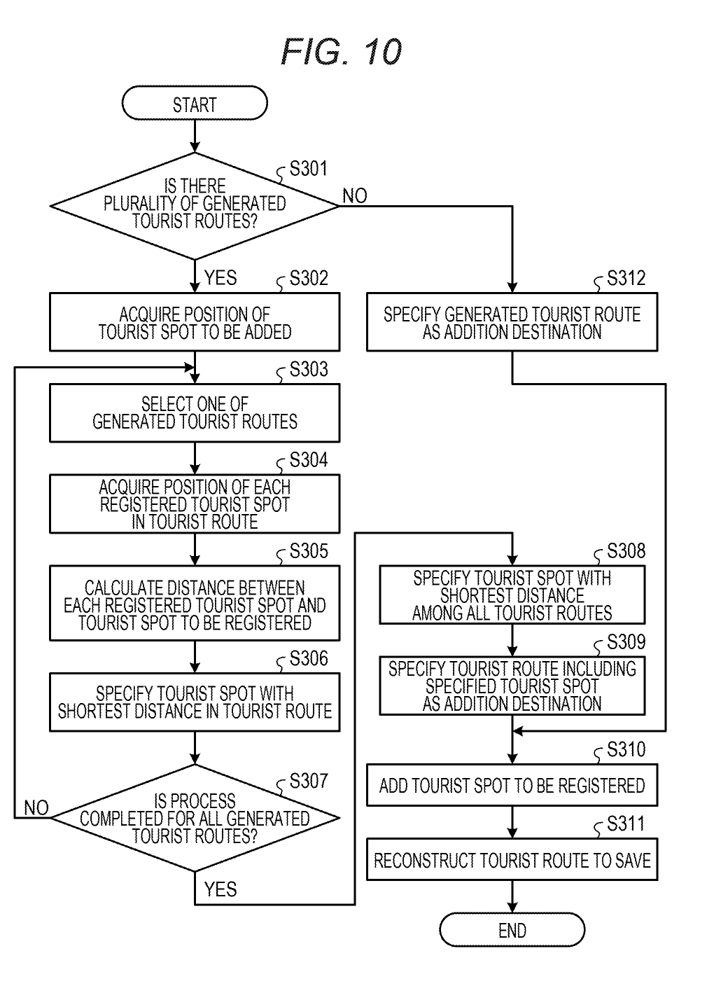

FIG. 10 is a flowchart illustrating a flow of the addition destination route specifying process. This process is a process executed in S206 of FIG. 9.

As illustrated in FIG. 10, when there is a plurality of generated tourist routes (S301: Yes), the route editing part 40 acquires the position of the tourist spot selected as an object to be added, from the tourist spot information DB 13 (S302).

Subsequently, the route editing part 40 selects one of the generated tourist routes (S303) and acquires the position of each registered tourist spot in the selected tourist route from the tourist spot information DB 13 (S304).

Then, using the acquired position information, the route editing part 40 calculates the distance between each registered tourist spot and the tourist spot to be added (S305) and specifies a tourist spot with the shortest distance in the tourist route being processed (S306).

Then, when there is an unprocessed tourist route among all the generated tourist routes (S307: No), S303 and the following steps are repeated for the next tourist route.

When the process is completed for all the generated tourist routes (S307: Yes), the route editing part 40 specifies the tourist spot with the shortest distance among all the tourist routes (S308) and specifies a tourist route including the specified tourist spot as the addition destination (S309). At this time, the route editing part 40 can also display the tourist route specified as the addition destination in a format different from other tourist routes. For example, the route editing part 40 highlights the specified tourist route, or changes colors or enlarges characters thereof.

Thereafter, the route editing part 40 adds the tourist spot to be added to the tourist route specified as the addition destination (S310), executes the reconstruction of the tourist route, and updates the route information DB 14 (S311).

In step S301, when there is not a plurality of generated tourist routes (S301: No), the route editing part 40 specifies the saved tourist route as the addition destination (S312) and executes S310 and the following steps.

[Effects]

As described above, the route generation server 10 is enabled to properly specify the tourist route to accept addition. While a plurality of tourist routes is generated as materials to be examined by the user, the user often has a difficulty in specifying to which tourist route a tourist spot where the user wants to make tourism is to be added. However, even in such a case, the route generation server 10 properly specifies the tourist route to accept addition such that reasonable and efficient movement is obtained.

In addition, when a destination is to be add to a roundabout route on a tourist site, the effort of transitioning to another screen to confirm the details of the tourist route is mitigated and, at the same time a generated and saved route to which the destination is suitably added and a model route are easily grasped. Furthermore, such operation is allowed to be executed transversally across different tourist sites where the tourist route generation service has been launched.

### Second Embodiment

The above-described first embodiment has described the example of using the distance between the tourist spots to specify the proper tourist route to accept addition; however, the present invention is not limited to this example and the proper tourist route to accept addition may be specified using information other than the distance.

Therefore, in a second embodiment, indices other than the distance will be described. Note that the respective techniques described in the second embodiment can be combined as appropriate within a range that does not cause conflict between the techniques, and the first and the second embodiments can be combined as appropriate within a range that does not cause conflict between the first and the second embodiments. For example, it is also practicable to specify a tourist route to accept addition, with another index after narrowing-down by the distance, or to specify a tourist route to accept addition, by the distance after narrowing-down by another index, or to highlight the tourist route specified as an object to accept addition.

(Area)

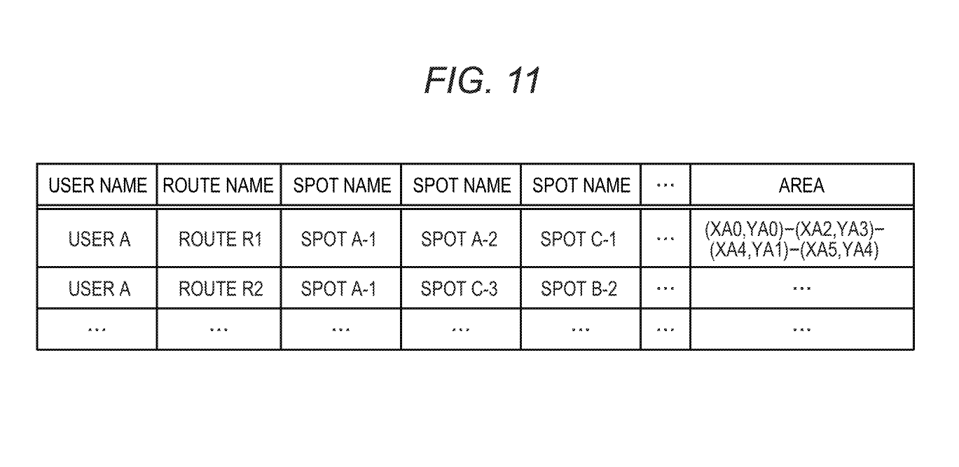

FIG. 11 is a diagram illustrating information stored in the route information DB 14, with which areas are associated. The difference from the first embodiment is that “area” is associated. This “area” indicates the smallest zone of the tourist route encompassing each tourist spot. When detecting the selection of the tourist spot to be added, the route editing part 40 acquires the latitude and longitude of the selected tourist spot from the tourist spot information DB 13. Then, the route editing part 40 searches the route information DB 14 for an area including the latitude and longitude of the selected tourist spot. Thereafter, the route editing part 40 specifies a tourist route including the tourist spot to be added in the own area, as the addition destination.

When a plurality of tourist routes including the tourist spot to be added in the own area is detected, the route editing part 40 can also specify each specified tourist route as the addition destination and transmit (display) each specified tourist route to (on) the user terminal 100. The route editing part 40 can also display a map or the like highlighting the area on the user terminal 100. This technique can also be adopted in the first embodiment. By adopting this technique, since the addition destination is specified by the concept of the area, the user is allowed to imagine the range of the tourist route, even if the user does not have enough acquaintance with the concerned region to have a sense of distance.

(Identifier)

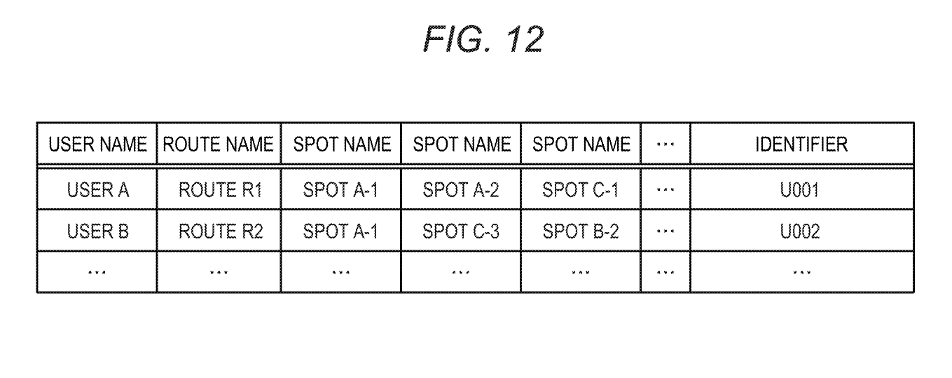

FIG. 12 is a diagram illustrating information stored in the route information DB 14, with which identifiers are associated. The difference from the first embodiment is that “identifier” is associated. This “identifier” is information for identifying the user who generated the tourist route and can be substituted with the user name; additionally, Cookie or the like can be used.

For example, when detecting the selection of the tourist spot to be added, the route editing part 40 acquires the latitude and longitude of the selected tourist spot from the tourist spot information DB 13 and also acquires an identifier “U001” from a web page on which the tourist spot has been selected, using Cookie or the like. Then, the route editing part 40 extracts a tourist route with which the identifier “U001” is associated from the route information DB 14 and specifies a tourist route as the addition destination from among the extracted tourist routes.

When at this point there is only one tourist route with which the identifier “U001” is associated, the route editing part 40 specifies this tourist route as the addition destination. Meanwhile, when there is a plurality of tourist routes with which the identifier “U001” is associated, the route editing part 40 specifies the addition destination using the distance described above and the like. Through this procedure, even when a plurality of users shares the tourist cloud 1 and the user terminal 100, the same user's operations are reliably processed without mistakes.

(Way of Movement)

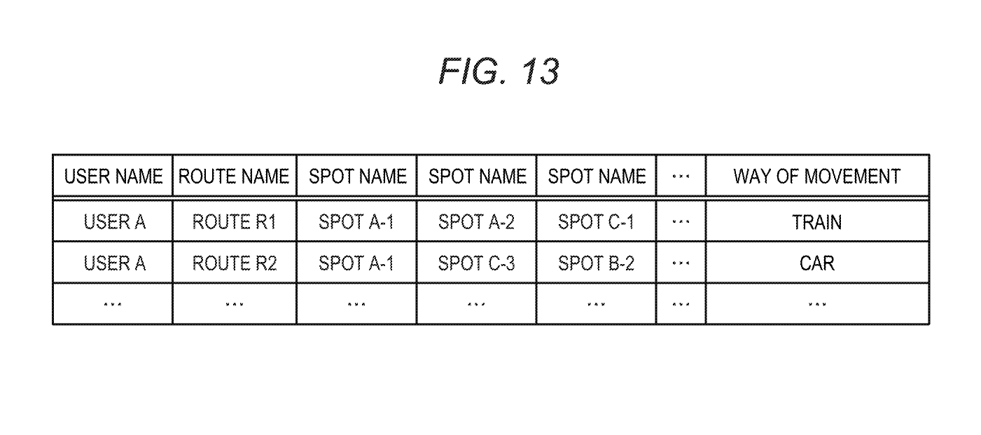

FIG. 13 is a diagram illustrating information stored in the route information DB 14, with which ways of movement are associated. The difference from the first embodiment is that “way of movement” is associated. This “way of movement” is information indicating a way of movement for the tourist route, such as a train, a car, or a walk.

For example, when detecting the selection of the tourist spot to be added, the route editing part 40 acquires the latitude and longitude of the selected tourist spot from the tourist spot information DB 13 and also acquires “car” set as the way of movement to the selected tourist spot by the user, via a web page or the like. Then, the route editing part 40 extracts a tourist route with which the way of movement “car” is associated from the route information DB 14 and specifies a tourist route as the addition destination from among the extracted tourist routes.

When at this point there is only one tourist route with which the way of movement “car” is associated, the route editing part 40 specifies this tourist route as the addition destination. Meanwhile, when there is a plurality of tourist routes with which the way of movement “car” is associated, the route editing part 40 specifies the addition destination using the distance described above and the like. Through this procedure, the tourist route is appropriately updated in consideration of the way of movement set by the user.

The way of movement is not restricted to a case where the user selects the way of movement but also a proper way of movement for visiting each tourist spot can be stored in the tourist spot information DB 13 in advance in association with each tourist spot. In this case, the route editing part 40 acquires the position and the way of movement of the tourist spot to be added from the tourist spot information DB 13. Then, the route editing part 40 extracts a tourist route with which the acquired way of movement is associated from the route information DB 14 and specifies a tourist route as the addition destination from among the extracted tourist routes.

(Time Information)

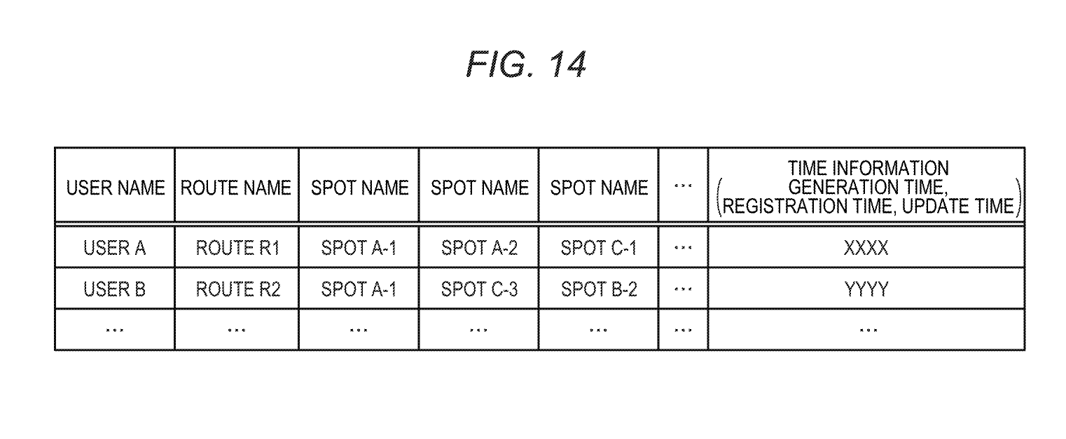

FIG. 14 is a diagram illustrating information stored in the route information DB 14, with which time information is associated. The difference from the first embodiment is that “time information” is associated. This “time information” is the generation time at which the tourist route was generated, the latest registration time at which the tourist spot was registered, the latest update time at which the tourist route was updated, and the like.

For example, when detecting the selection of the tourist spot to be added, the route editing part 40 acquires the latitude and longitude of the selected tourist spot from the tourist spot information DB 13. Then, the route editing part 40 extracts a tourist route with the latest time information from the route information DB 14 and specifies the extracted tourist route as the tourist route as the addition destination. Through this procedure, the tourist spot is appropriately added by presuming the tourist route most considered by the user.

### Third Embodiment

While the embodiments have been described so far, another embodiment may be carried out in various different forms in addition to the above-described embodiments.

[Application System]

In the above embodiments, the tourist route has been described as an example; however, the disclosure is not limited to this example and can be applied to a variety of circulation routes. For example, another embodiment can be similarly applied to a circulation route that a security guard goes along in the case of, for example, adding a new security point.

[Hardware]

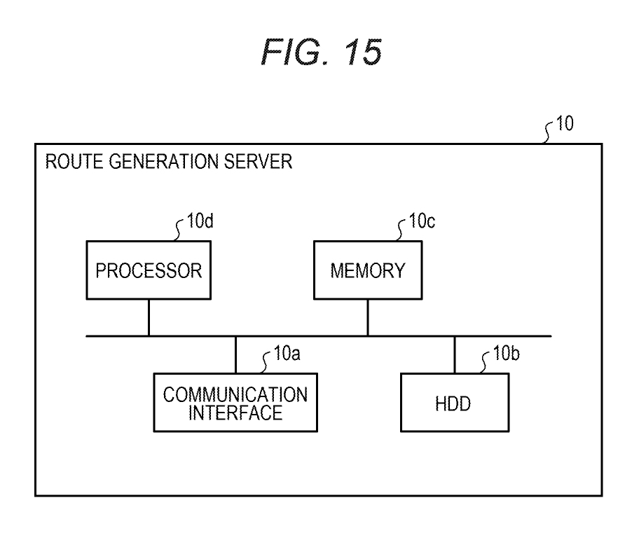

FIG. 15 is a diagram illustrating an example of a hardware configuration. As illustrated in FIG. 15, the route generation server 10 has a communication interface 10a, a hard disk drive (HDD) 10b, a memory 10c, and a processor 10d. The respective parts illustrated in FIG. 15 are mutually coupled by a bus or the like.

The communication interface 10a is a network interface card or the like and communicates with another server. The HDD 10b stores programs and DBs for activating the functions illustrated in FIG. 2.

The processor 10d reads a program that executes a process similar to the process of each processing part illustrated in FIG. 2 from the HDD 10b or the like to develop the read program in the memory 10c, thereby activating a process that executes each function described with reference to FIG. 2 and other drawings. For example, this process executes a function similar to the function of each processing part included in the route generation server 10. In detail, the processor 10d reads a program having functions similar to the functions of the login processing part 21, the route generation part 30, the route editing part 40, and the like from the HDD 10b or the like. Then, the processor 10d executes a process that executes processes similar to the processes of the login processing part 21, the route generation part 30, the route editing part 40, and the like.

In this manner, the route generation server 10 is activated as an information processing device that executes a route generation method by reading and executing the program. The route generation server 10 can also implement functions similar to the functions of the above-described embodiments by reading the program described above from a recording medium by a medium reading device and executing the read program described above. This program referred to in other embodiments is not limited to being executed by the route generation server 10. For example, the embodiments can be similarly applied to a case where another computer or server executes the program, or a case where such computer and server cooperatively execute the program.

Examples of the memory 10c include a random access memory (RAM) such as a synchronous dynamic random access memory (SDRAM), a read only memory (ROM), a flash memory and the like. Examples of the processor 10d include a central processing unit (CPU), a digital signal processor (DSP), a field programmable gate array (FPGA), a programmable logic device (PLD) and the like.

[System]

Among all the processes described in the present embodiments, all or a part of the processes described as being automatically performed can be manually performed. Alternatively, all or a part of the processes described as being performed manually can be automatically performed by a known method. Besides, any information indicated in this document or the drawings, including the processing procedures, control procedures, specific names, and various sorts of data and parameters can be arbitrarily modified unless otherwise noted.

The respective constituent elements of each device illustrated in the drawings are functionally conceptual and do not necessarily have to be physically configured as illustrated in the drawings. For example, specific forms of distribution and integration of the respective devices are not restricted to the forms illustrated in the drawings. This means that all or a part of the devices can be configured by being functionally or physically distributed and integrated in arbitrary units according to various sorts of loads and usage situations. Furthermore, all or an arbitrary part of respective processing functions performed in the respective devices may be implemented by a CPU and a program analyzed and executed by the CPU, or may be implemented as hardware by wired logic.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a circulation route creation support program for causing a computer to execute a process comprising:
outputting, when accepting a search request for a spot, information related to one or more spots which satisfy a condition of the search request;
referring to, when any one of the output one or more spots is selected as a first spot, a first storage part that stores a spot and a position of the spot in association with each other, and acquiring a position of the first spot; and
referring to a second storage part that stores a plurality of circulation routes each including at least one or more spots and, on the basis of a position of the at least one or more spots included in each of the plurality of circulation routes and the acquired position of the first spot, specifying a circulation route as an addition candidate for the selected first spot, from among the plurality of circulation routes.

2. The non-transitory computer-readable recording medium according to claim 1, wherein the selected first spot is automatically registered in the specified circulation route.

3. The non-transitory computer-readable recording medium according to claim 1, wherein the circulation route specified as the addition candidate is displayed in a manner different from a manner of the other circulation routes among the plurality of circulation routes.

4. The non-transitory computer-readable recording medium according to claim 1, wherein the selected first spot is registered in a circulation route selected from among the plurality of displayed circulation routes.

5. The non-transitory computer-readable recording medium according to claim 1, wherein the spot is a tourist spot.

6. The non-transitory computer-readable recording medium according to claim 1, wherein the circulation route is a tourist route.

7. The non-transitory computer-readable recording medium according to claim 1, wherein the second storage part further stores area information indicating areas in association with the respective circulation routes and the circulation route associated with an area including the acquired position of the first spot is specified.

8. The non-transitory computer-readable recording medium according to claim 1, wherein the first storage part further stores a way of movement to the spot in association with the spot, a position of the first spot and a way of movement to the first spot are acquired, and according to classification information on the acquired way of movement, a circulation route as the addition candidate for the selected first spot is specified from among the plurality of circulation routes.

9. The non-transitory computer-readable recording medium according to claim 1, wherein a process of the specifying causes the computer to execute a process of generating a new route when the acquired position of the first spot is apart from a position of a spot included in each of the plurality of circulation routes by a predetermined distance or more.

10. The non-transitory computer-readable recording medium according to claim 1, wherein
the second storage part further stores identification information that identifies an account, in correlation with each of the circulation routes,
the process includes acquiring the identification information, wherein
a process of the specifying further causes the computer to execute a process of specifying, on the basis of a position of a spot included in each of circulation routes with which the acquired identification information is correlated, among the plurality of circulation routes stored in the second storage part, and the acquired position of the first spot, a circulation route as the addition candidate for the first spot, from among the circulation routes with which the acquired identification information is correlated.

11. A non-transitory computer-readable recording medium having stored therein a circulation route creation support program for causing a computer to execute a process comprising:
outputting, when accepting a search request for a spot, information related to one or more spots which satisfy a condition of the search request; and
referring to, when any one of the output one or more spots is selected, a storage part that stores each of a plurality of circulation routes each including at least one or more spots, in association with creation time, registration time, or update time of each of the plurality of circulation routes and, on the basis of the creation time, the registration time, or the update time of each of the plurality of circulation routes, specifying a circulation route with latest creation time, registration time, or update time, from among the plurality of circulation routes.

12. The non-transitory computer-readable recording medium according to claim 11, wherein the specified circulation route is displayed in a manner different from a manner of the other circulation routes among the plurality of circulation routes.

13. A circulation route creation support method comprising:
outputting, by a computer, when accepting a search request for a spot, information related to one or more spots which satisfy a condition of the search request;
referring to, by the computer, when any one of the output one or more spots is selected as a first spot, a first storage part that stores a spot and a position of the spot in association with each other, and acquiring a position of the first spot; and
referring to, by the computer, a second storage part that stores a plurality of circulation routes each including at least one or more spots and, on the basis of a position of the at least one or more spots included in each of the plurality of circulation routes and the acquired position of the first spot, specifying a circulation route as an addition candidate for the selected first spot, from among the plurality of circulation routes.
